(19) United States
(12) Patent Application Publication
(10) Pub. No.: US 2004/0156559 A1
(43) Pub. Date: Aug. 12, 2004

(54) Method and apparatus for measuring quality of compressed video sequences without references

(75) Inventors: Hui Cheng, Bridgewater, NJ (US); Jeffrey Lubin, Princeton, NJ (US)

Correspondence Address: MOSER, PATTERSON & SHERIDAN, LLP, /SARNOFF CORPORATION, 595 SHREWSBURY AVENUE, SUITE 100, SHREWSBURY, NJ, 07702, US

(73) Assignee: Sarnoff Corporation

(21) Appl. No.: 10/722,348

(22) Filed: Nov. 25, 2003

Related U.S. Application Data
(60) Provisional application No. 60/428,878, filed on Nov. 25, 2002.

(51) Int. Cl. G06K 9/36

(52) U.S. Cl. 382/286

(57) ABSTRACT

A method and apparatus for implementing no-reference quality measure of compressed image sequences, e.g., MPEG (Moving Picture Experts Group) compressed image sequences. The present invention discloses an NRQ (No-Reference Quality) measure for compressed image sequences that is formulated from a set of image tributes derived directly from individual image frames (or fields for interlaced video). These tributes can be divided into two broad categories: those that measure the strength of artifacts (artifact measures) and those that are used by a compression method to control the quality of compressed image sequence.

This application claims the benefit of U.S. Provisional Application No. 60/428,878 filed on Nov. 25, 2002, which is herein incorporated by reference in its entirety.

This invention was made with U.S. government support under contract number NMA202-97-D-1033 of NIMA/PCE. The U.S. government has certain rights in this invention.

### BACKGROUND OF THE INVENTION

1. Field of the Invention

The present invention generally relates to a method and apparatus for measuring the quality of a compressed image sequence without the use of a reference image sequence. More specifically, the no-reference quality (NRQ) measure is implemented by computing tributes derived directly from the compressed image sequences.

2. Description of the Related Art

The rapid commercialization of digital video technology has created an increasing need for the automatic measuring of video quality throughout its production and distribution. It is often the case that the original image sequence is processed, e.g., compressed, to reduce the size of the original image sequence. Unfortunately, there are numerous compression methods that can be employed with each method producing compressed image sequences of varying quality.

As of today, the most effective way to measure the quality of an image sequence is to measure the difference between the image sequence and a reference image sequence, such as the original image sequence before it was processed, compressed, distributed or stored. In other words, one can decompress the compressed image sequence and compare it with the original image sequence. The discrepancy is indicative of the image quality of the image sequence itself and also indirectly, the quality of the compression method that was employed to generate the compressed image sequence. However, for many applications, such as video broadcasting, streaming or downloading, a reference image sequence is generally not available to the end-users. In addition, the reference-based approach measures the visibility of difference between two images, and not the image quality itself.

Therefore, there exists a need in the art for a method and apparatus for accurately measuring the quality of an image sequence without the need for a reference image sequence, i.e., a method for a no-reference quality (NRQ) measure of image sequences.

### SUMMARY OF THE INVENTION

In one embodiment, the present invention discloses a method and apparatus for implementing no-reference quality measure of compressed image sequences, e.g., MPEG (Moving Picture Experts Group) compressed image sequences. Most end users who use compressed video cannot access the original image sequence before the compression. Therefore, a NRQ measure is beneficial to the users for measuring quality of the compressed image sequence that they received.

The present invention discloses an NRQ measure for compressed image sequences that is formulated from a set of image tributes derived directly from individual image frames (or fields for interlaced video). These tributes can be divided into two broad categories: those that measure the strength of artifacts (artifact measures) and those that are used by a compression method to control the quality of compressed image sequence.

For example, since a MPEG compressed image sequence has a limited number of artifacts, such as blocking, ringing and blurring, reference free measures for one or more of these artifacts can be established first as features of the NRQ of the entire sequence. In addition, coding parameters of MPEG (such as bit-rate, quantization tables, quality factors) and quantized DCT coefficients are also directly related to quality of the compressed video. Therefore, if encoded bit streams are available, coding parameters of the encoded bit streams can also be used as features of the NRQ measure. If these coding parameters are not available, then they will be estimated and their estimates are used as features of the NRQ.

Finally, by combining these features, an NRQ of compressed image sequence can be established. The parameters of the NRQ will be estimated through training with typical image sequences compressed using a particular compression method, e.g., MPEG, and their subject quality ratings can be obtained by psychophysical experiments.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates a block diagram showing an exemplary no-reference quality (NRQ) measuring system of the present invention implemented using a general purpose computer;

FIG. 2 illustrates a block diagram showing an exemplary no-reference quality (NRQ) measuring module;

FIG. 3 illustrates a flowchart of a method for generating a ringing artifact measure in accordance with the present invention;

FIG. 4 illustrates uniform regions, regions adjacent to edges, and edges within an image;

FIG. 5 illustrates a flowchart of a method for generating a blocking or quantization artifact measure in accordance with the present invention;

FIG. 6 illustrates the max function as applied to generate the quantization artifact measure in accordance with the present invention;

FIG. 7 illustrates a flowchart of a method for generating a resolution artifact measure in accordance with the present invention;

FIG. 8 illustrates the orientation of the vertical frequency and the horizontal frequency when an FFT is applied to an image;

FIG. 9 illustrates a profile of an averaging function;

FIG. 10 illustrates a flowchart of a method for generating a sharpness artifact measure in accordance with the present invention; and

FIG. 11 illustrates a method for generating a no-reference quality (NRQ) measuring prediction.

### DETAILED DESCRIPTION OF THE INVENTION

A generic NRQ measure of an image sequence is desirable, but is very difficult to establish, because the quality of an image sequence depends not only on its content, but also on the human perception of the world, such as shape, color, texture and motion behavior of natural objects. However, when the image processing method applied to an image sequence is known, characteristics of the processed image sequence and/or the characteristics of the distortion introduced by the process can be derived. Therefore, an NRQ measure can be formulated accordingly.

In the present disclosure, a method and apparatus for measuring the NRQ of MPEG compressed image sequences is disclosed. Currently, MPEG compression is a state-of-art video compression technology and is widely used for video storage and distribution. Although the present invention is described in the context of MPEG encoding, the present invention is not so limited. Namely, the present invention can be adapted to operate with other compression methods such as H.261, H.263, JVT, MPEG2, MPEG4, JPEG, JPEG2000, and the like.

Additionally, the present invention is described within the context of compression of an image sequence. However, the present invention is not so limited. Other types of image processing can be applied to the original input image sequence that may impact the quality of the image sequence. These image processings may not involve compression of the image sequence, e.g., transmission of the image sequence where noise is introduced. The present invention can be applied broadly to measure the quality of the “processed” image sequence without the need of a reference image or a reference image sequence. Finally, the present invention can be applied to a single image or to an image sequence.

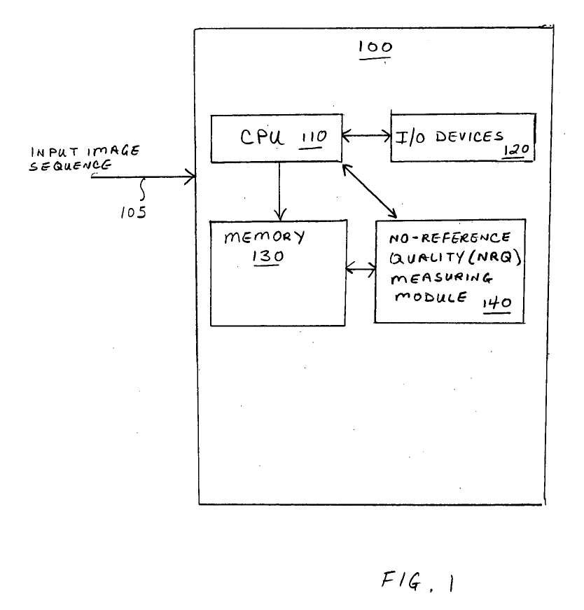

FIG. 1 depicts a block diagram showing an exemplary no-reference quality (NRQ) measuring system 100 of the present invention. In this example, the no-reference quality (NRQ) measuring system 100 is implemented using a general purpose computer. Specifically, the (NRQ) measuring system 100 comprises (NRQ) measuring module 140, a central processing unit (CPU) 110, input and output (I/O) devices 120, and a memory unit 130.

The I/O devices may comprise a keyboard, a mouse, a display, a microphone, a modem, a receiver, a transmitter, a storage device, e.g., a disk drive, an optical drive, a floppy drive and the like. Namely, the I/O devices broadly include devices that allow inputs to be provided to the (NRQ) measuring system 100, and devices that allow outputs from the (NRQ) measuring system 100 to be stored, displayed or to be further processed.

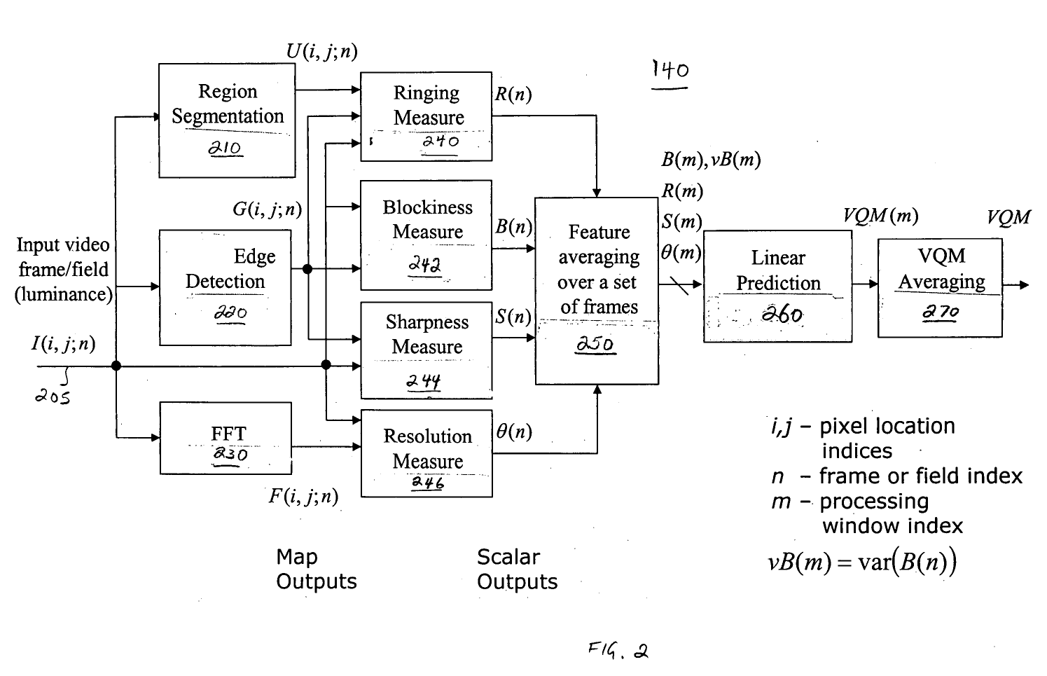

The (NRQ) measuring module 140 receives an input image sequence, e.g., a compressed image sequence, on path 105 and determines the quality of the image sequence without the need of a reference image sequence. In one embodiment, the (NRQ) measuring module 140 may generate a plurality of image measures that are evaluated together to determine the overall quality of the image sequence. The input image sequence may comprise images in frame or field format. The (NRQ) measuring module 140 and the resulting image measures are further described below in connection with FIG. 2.

The central processing unit 110 generally performs the computational processing in the no-reference quality (NRQ) measuring system 100. In one embodiment, the central processing unit 110 loads software from an I/O device to the memory unit 130, where the CPU executes the software. The central processing unit 120 may also receive and transmit signals to the input/output devices 120. In one embodiment, the methods and data structures of the (NRQ) measuring module 140 can be implemented as one or more software applications that are retrieved from a storage device and loaded into memory 130. As such, the methods and data structures of the (NRQ) measuring module 140 can be stored on a computer readable medium.

Alternatively, the (NRQ) measuring module 140 discussed above can be implemented as a physical device that is coupled to the CPU 110 through a communication channel. As such, the (NRQ) measuring module 140 can also be represented by a combination of software and hardware, i.e., using application specific integrated circuits (ASIC).

FIG. 2 illustrates a block diagram showing an exemplary no-reference quality (NRQ) measuring module 140 of the present invention. The no-reference quality (NRQ) measuring module 140 comprises a region segmentation module 210, an edge detection module 220, a transform module 230, a ringing measure module 240, a blockiness or quantization measure module 242, a sharpness measure module 244, a resolution measure module 246, a feature averaging module 250, a linear prediction module 260 and a VQM averaging module 270.

In operation, an input image sequence, e.g., a compressed image sequence, is received on path 205. The image (frame or field) is forwarded to region segmentation module 210 where uniform and non-uniform regions are detected. Similarly, the image (frame or field) is forwarded to edge detection module 220, e.g., a Canny edge detector, where edges in the image are detected. Finally, the image (frame or field) is also forwarded to transform module, e.g., a FFT module, where a transform is applied to the image.

In turn, depending on the information that is needed, the outputs from modules 210, 220 and 230 are provided to four artifact measure modules 240-246. The functions of these artifact modules are described below.

In turn, the artifact measures are then averaged over a set of frames, e.g., 30 frames. Additionally, the variances are also generated by module 250.

In turn, a linear prediction is applied to the averages and the variances to generate the overall no-reference quality (NRQ) measure or video quality measure (VQM) in modules 260 and 270. The linear prediction module 260 generally produces results for a frame or a field, whereas the averaging module 270 can be used to generate an average over a plurality of frames and fields.

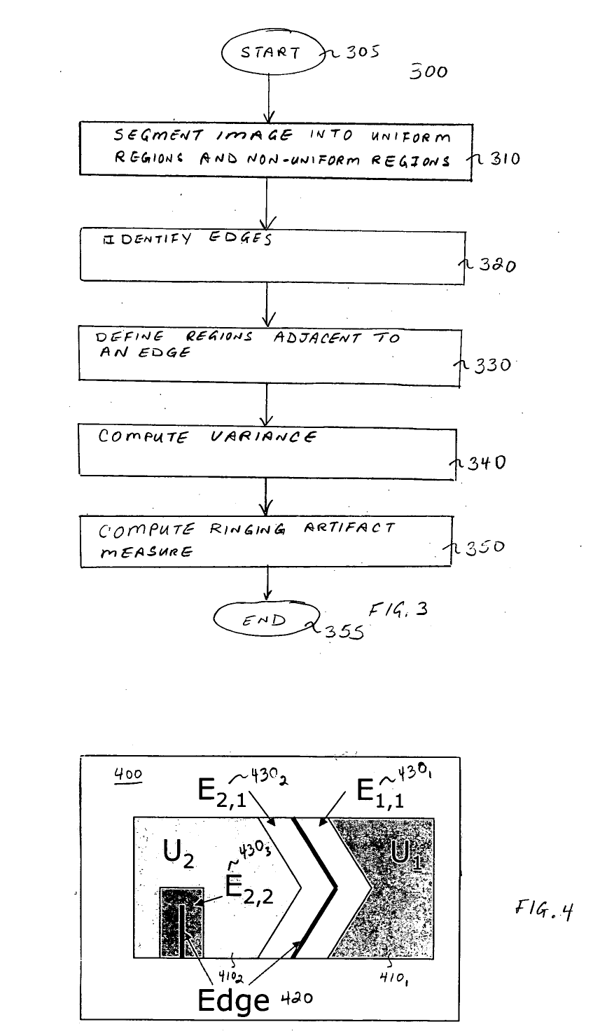

FIG. 3 illustrates a flowchart of a method 300 for generating a ringing artifact measure in accordance with the present invention. Ringing artifact is caused by the quantization error of high frequency components used in MPEG compression. It often occurs around sharp edges on uniform background, where sharp edges have large high frequency content and a uniform background makes the artifact more visible. Therefore, the present invention discloses a measure of ringing artifact that calculates the ratio of activities between a uniform region and areas of the same region around sharp edges. The reader is encouraged to refer simultaneously to both FIGS. 3 and 4 to better understand the present disclosure.

Specifically, method 300 starts in step 305 and proceeds to step 310 where an image is segmented into uniform regions and non-uniform regions. The uniform regions are identified in FIG. 4 as U₁ 410₁ and U₂ 410₂. Namely, the connected component of the uniform regions is denoted as Uᵢ.

In step 320, method 300 identifies one or more edges 420 within the image 400. Edge detection is well known in the art of image processing. An example of an edge detector can be found in A. K. Jain, “Fundamentals of Digital Image Processing,” Prentice Halls, 1989 or for a Canny edge detection by J. Canny, “A computational approach to edge detection,” IEEE Transactions on Pattern Analysis & Machine Intelligence, vol.PAMI-8, no.6, November 1986, pp. 679-98. USA

In step 330, method 300 defines regions E adjacent to an edge. Specifically, method 300 define E as the set of pixels 430 that are not edge pixels, but are adjacent to edges 420 (e.g., less than 7 pixels away from an edge pixel for a 8×8 block or less than 15 pixels away from an edge pixel for a 16×16 block). It should be noted that the number of pixels away from an edge pixel can be made to be dependent on the block size employed by a particular compression method. Method 300 also denotes the j^{th} connected component of the intersection of E and Uᵢ as E_{i,j}.

In step 340, method 300 computes the variance of E_{i,j} and the variance of Uᵢ.

In step 350, method 300 applies the variance of E_{i,j} and the variance of Uᵢ to derive a ringing measure. In one embodiment, the ringing artifact measure for E_{i,j}, R(E_{i,j}) is the variance of E_{i,j} normalized by the variance of Uᵢ, if the number of pixel of E_{i,j} is larger than a threshold M. For a pixel (i,j),

$${R}_{i , j} = \{ \begin{matrix}\frac{var ( {E}_{i , j} )}{var ( {U}_{i} )} , & ∃ i , j ∋ x ε {E}_{i , j} ⋀ \vert {E}_{i , j} \vert > M \\ 0 , & otherwise\end{matrix} . \qquad Equ . ( 1 )$$

The larger R_{i,j} is, the more likely the ringing occurs. In addition, the ringing artifact measure also generates a map that indicates the location of the ringing artifacts. The ringing artifact measure R for the whole frame is the Q-norm of all non-zero R_{i,j}, where Q=1. Definition of Q-norm with Q=q can be expressed as:

$$Q\_norm ( {a}_{1} , {a}_{2} , ⋯ , {a}_{N} ) = \sqrt[q]{\frac{{\sum }_{i = 1}^{N} {a}_{i}^{q}}{N}} \qquad Equ . ( 1 a )$$

In other words, the present invention accounts for the observation that it tends to be noisier in the regions that are closer to edges within an image. Thus, if the variance of a region adjacent to an edge is substantially different than a variance of a corresponding uniform region, then it will produce a large ringing artifact measure R. Such large ringing artifact measure R is indicative of a poor encoding algorithm that in turn, will generate a compressed image sequence of poor quality. In contrast, a better compression algorithm should produce a uniform region that should approach an edge without any noticeable change, e.g., where the variance of the region 430₁ adjacent to an edge divided by the variance of the uniform region 410₁ should be close to a value of 1.

Alternatively, the region 430 adjacent to an edge can be defined as a block or a window centered around a pixel. This alternate approach can be used to provide a localized or pixel-wise ringing measure. For example, define:

Uₖ is the k-th uniform region;

Eₖ is a region adjacent (e.g., 4 pixels away) to strong edge(s) in Uₖ, where Eₖ can be computed using morphological operations;

E_{k,l} is the I^{th} connected component of Eₖ;

then R(i,j,n) is a pixel-wise local ringing measure, where σ (i, j;8) is the 8-nearest neighbors of (i,j) and

$$R ( i , j ; n ) = \{ \begin{matrix}\frac{var ( {E}_{k , l} ⋃ σ ( i , j ; 8 ) )}{var ( {U}_{k} )} , & if ∃ ( k , l ) , ( i , j ) ∈ {E}_{k , l} \\ 0 , & otherwise\end{matrix} . \qquad Equ . ( 2 )$$

Furthermore, R(n), the ringing measure of the frame, is the Q-norm of all non-zero local ringing measures, with Q=4. It should be noted that the window of any size can be used.

FIG. 5 illustrates a flowchart of a method 500 for generating a blocking or quantization artifact measure in accordance with the present invention. Besides ringing artifact, blocking or quantization artifact is another major artifact associated with MPEG compression. Namely, transforms coefficients are often quantized in a compression method. The result is the appearance of artifacts around the edges of adjacent blocks, especially on the corners of the blocks.

Method 500 starts in step 505 and proceeds to step 510 where method 500 computes the horizontal contrasts at each pixel. For example, at each pixel, the contrast between two adjacent pixels is computed, e.g., the difference of the luminance values between two adjacent values is divided by the average value of the two pixels. For example, the horizontal contrast can be expressed:

C_{i,j}^{h}=(L_{i,j}−L_{i-1,j})/(L_{i,j}+L_{i-1,j}) Equ. (3)

In step 515, method 500 applies one or more filtering functions. For example, the horizontal contrast values can be filtered as follows:

if C_{i,j}^{h}>Tᵤₚ||C_{i,j}^{h}<T_{low} set it to 0. Tᵤₚ=0.25 and T_{low}=0.04 Equ. (4)

Thus, the visibility of these edges and corners must be properly assessed for the purpose of evaluating the quality of the image sequence. For example, if the edges and corners are very prominent (having a strong contrast), then there is a possibility that it is actually an image feature and not an artifact. Similarly, if the edges and corners are not very prominent and not perceivable, then it is not necessary to mark it as a quality problem. In other words, since quantization artifact is caused by the quantization error of the low frequency components, the corresponding horizontal or vertical contrast is generally smaller than an upper threshold. Also since quantization artifact is visible, the corresponding horizontal or vertical contrast needs to be larger than a lower threshold. Therefore, all contrasts larger than the upper threshold Tᵤₚ or smaller than the lower threshold T_{low} cannot be caused by quantization artifact, and they are set to zero. It should be noted that Tᵤₚ and T_{low} can be selected in accordance with a particular implementation and is not limited to 0.25 and 0.04.

Additionally, the contrast values can be filtered to remove slow-varying areas and weak lines. For example, the horizontal contrast values can be filtered as follows:

D_{i,j}^{h}=C_{i,j}^{h}/max(σ·C_{i,j}^{h},c_{i,j}), σ=0.01

c_{i,j}=max(C_{i-3,j}^{h},C_{i-2,j}^{h},C_{i+1,j}^{h},C_{i+2,j}^{h},C_{i+3,j}^{h})/C_{i,j}^{h} Equ. (5)

where horizontal contrast will be increased if it is the sole local maxima

In addition to quantization artifact, gradient regions or weak lines also have the contrast within the two thresholds. To filter out these signals, the pixel-wise masking of equation (5) is applied independently to horizontal and vertical contrast separately. In this step, it is described only as being used on the horizontal contrast as an example. Let C_{i,j}^{h} and D_{i,j}^{h} be the horizontal contrast and the masked contrast at pixel (i,j), respectively. The masking only enhances contrast whose absolute value is much larger than the absolute values of its six nearest neighbors in 1-D. The maximal enhancement is determined by a. For gradient regions and weak lines, there generally are neighbors with similar or higher absolute contrast. Therefore, they are not enhanced.

In step 520, method 500 sums contrast values over a sliding window, e.g., a 1×8 sliding window for use with compression methods that employ 8×8 block size. For example, S_{i,j}^{h} is the sum of D_{i,j}^{h} over the sliding 1×8 window. Because the blocking artifact only occurs at 8×8 or 16×16 block boundaries, and the most noticeable feature of quantization artifact is the block corner, the present invention uses the following metric to measure the visibility of all possible corners in a video frame. First, the horizontal (vertical) contrasts are summed over 1×8 (8×1) in an overlapping fashion. Method 500 define the summation of masked horizontal (vertical) contrasts over a 1×8 window as S_{i,j}^{h}(S_{i,j}^{v}).

Steps 525-535 are simply the same steps as steps 510-520 except that steps 525-535 are applied to compute the vertical contrasts.

In step 540, method 500 computes the quantization artifact measure. Namely, at each pixel (i,j), the visibility of four corners are computed and the maximum of the four is assigned to V_{i,j}. For example, the quantization artifact measure can be expressed as follows:

V_{i,j}=max(|S_{i,j}^{h}+S_{i,j}^{v}|,|S_{i,j}^{h}−S_{i-7,j}^{v}|,|S_{i,j-7}^{h}+S_{i,j}^{v}|,|S_{i,j-7}^{h}+S_{i-7,j}^{v}|) Equ. (6)

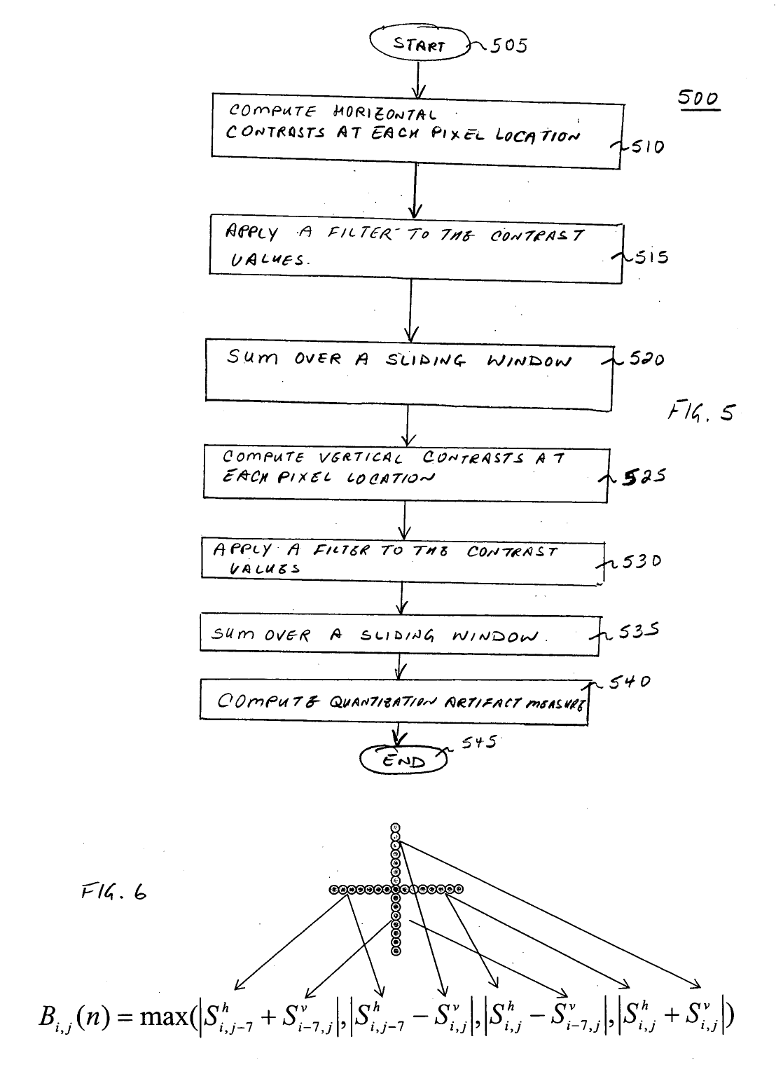

FIG. 6 illustrates this max function. The larger V_{i,j} is, the more likely the quantization artifact occurs. In addition, the quantization artifact measure also generates a map that indicates the location of any quantization artifacts. The quantization artifact measure V for the whole frame is the Q-norm of all non-zero V_{i,j} normalized by local variance.

$$V = \sqrt[4]{\frac{{Σ ( {V}_{i , j} / {v}_{i , j} )}^{4}}{Σ1 / {v}_{i , j}}} \qquad Equ . ( 7 )$$

where v_{i,j} is the variance of the 9×9 neighborhood centered at (i,j).

FIG. 7 illustrates a flowchart of a method 700 for generating a resolution artifact measure in accordance with the present invention. MPEG compressed image sequence also suffers from blurring. Namely, it is beneficial to determine the present resolution of the image. The present invention discloses a method to measure the resolution artifact using frequency analysis of each individual frame.

Method 700 starts in step 705 and proceeds to step 710 where a transform, e.g., Fast Fourier Transform (FFT) is applied to the entire image. Let F_{u,v} be the amplitude of the FFT of the current frame.

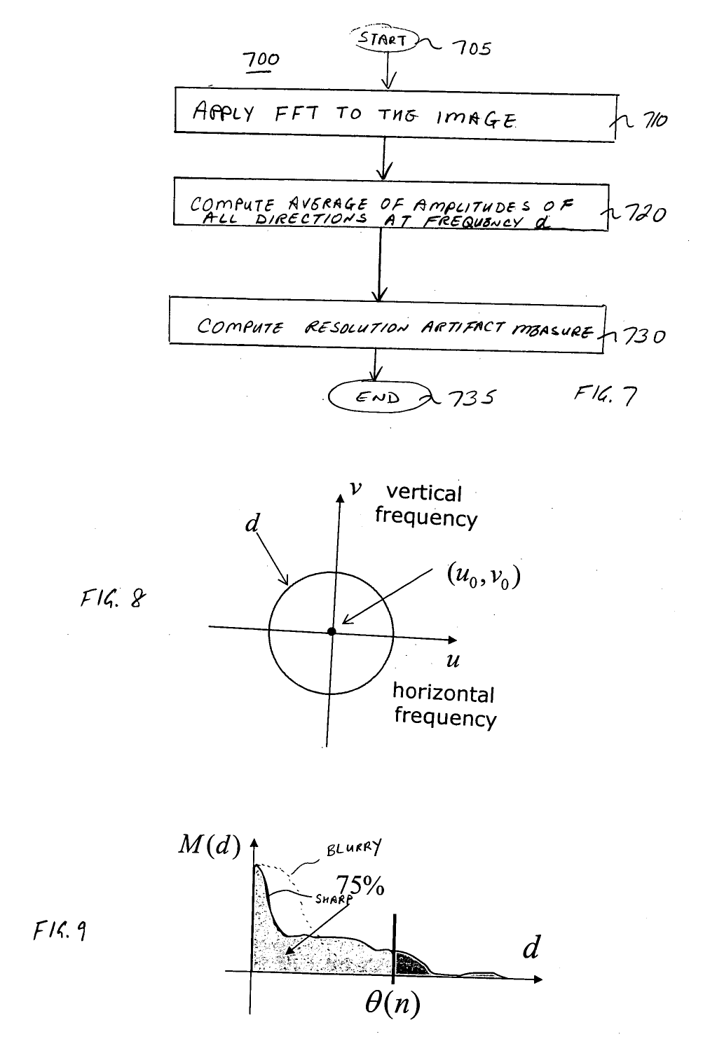

In step 720, method 700 defines and computes the average M(d) of amplitudes of all directions at radial frequency d with (u₀, vₒ) being the DC indices. This is illustrated in FIG. 8. For example, M(d) can be expressed:

$$M ( d ) = \frac{1}{2 πd} . {{ΣF}_{u , v}}_{\sqrt{{( u - {u}_{0} )}^{2} + {( v - {v}_{0} )}^{2}} = d} \qquad Equ . ( 8 )$$

In step 730, method computes a resolution artifact measure for the image. For example, the measure of resolution, E is expressed as:

$$E = \frac{{\sum }_{d = N / 6}^{N} M ( d )}{{\sum }_{d = 1}^{N / 6 - 1} M ( d )} . \qquad Equ . ( 9 )$$

E measures the ratio between the accumulated mid to high frequency amplitude and the accumulated low frequency amplitude. When E is smaller, it is representative that the current frame contains more low frequency content and may appear to be blurred. This is illustrated in the profile as shown in FIG. 9. Resolution of the frame n, θ (n), is the frequency when the sum of the area beneath the MTF reaches, e.g., 75% (which is empirically determined) of the total area under the MTF. If the image is blurry, then the curve will not drop sharply since the frequency will be close to the DC, whereas if the image not blurry, then the curve will drop sharply since the frequency will not be close to the DC.

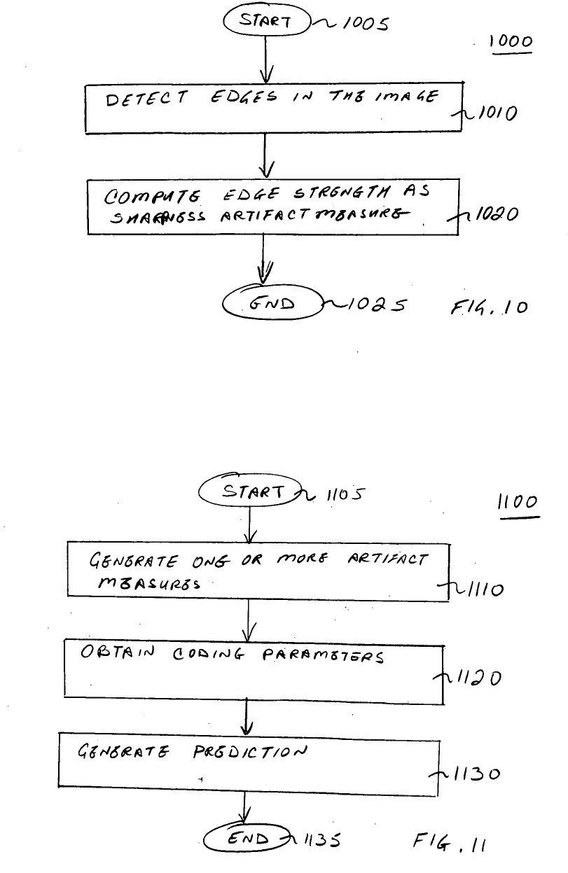

FIG. 10 illustrates a flowchart of a method 1000 for generating a sharpness artifact measure in accordance with the present invention. Sharpness is a measure of the sharpness of the edges in the image, where sharpness is defined as edge strength. In other words, a high rate of gradient change is deemed to be representative of sharpness. In some situations, the sharpness of edges in the image content is lost when a compression algorithm blurs the edges that are part of the image content.

Method 1000 starts in step 1005 and proceeds to step 1010, where method 1000 detects edges in an image. Edge detection can be implemented by using the Canny edge detector.

In step 1020, method 1000 computes edge strength as a sharpness artifact measure. Specifically, S(n) is defined as the mean of edge strength, e.g., by using the Canny edge detector, at edge points. Let s_{i,j} be the edge strength at pixel (i,j) computed by the Canny edge detector. Let w_{i,j} be 1 if s_{i,j}>15, otherwise be 0. Thus, S(n) can be expressed as:

$$S ( n ) = \frac{{\sum }_{i} {\sum }_{j} {s}_{i , j} \cdot {w}_{i , j}}{{\sum }_{i} {\sum }_{j} {w}_{i , j}} \qquad Equ . ( 10 )$$

Thus, for each frame or field within an input image sequence, the present invention can generate up to four (4) artifact measures. It should be noted that the number of artifact measures that are generated is a function of the requirement of a particular implementation. Thus, it is possible to employ all four artifact measures or simply a subset of these four artifact measures.

In one embodiment, for a set of frames, e.g., a sliding window of 30 frames, the present invention will obtain an average of these four artifact measures and the variances of these four artifact measures. For example, Q-norm with Q=1 (average) is used for feature averaging with average features computed from the m-th sliding window. For example, the average can be expressed as:

$$R ( m ) = [ \frac{1}{30} {\sum }_{n = m}^{m - 29} R ( n ) ] \qquad Equ . ( 11 )$$

Variance of the feature values over the same sliding window are also computed as well:

vB(m)=var({B(m),B(m−1), . . . B(m−29)}) Equ. (12)

In turn, these averages and variances will be applied in a prediction disclosed below.

FIG. 11 illustrates a method 1100 for generating a no-reference quality (NRQ) measuring prediction that combines artifact measures and coding parameters. Namely, FIG. 11 illustrates an optional method where coding parameters can be obtained to supplement the artifact measures to improve the no-reference quality (NRQ) measuring prediction. For example, besides artifact measures, encoding parameters and quantized DCT coefficients are also closely related to the quality of the MPEG compressed image sequence. Encoding parameters, such as target bit rate, quantization tables and quantization factors are used to control the compressed image quality. Quantization tables, quantization factors and quantized DCT coefficients can also be used to further improve the accuracy of artifact measures.

Method 1100 starts in step 1105 and proceeds to step 1110, where one or more artifact measures can be generated. The generation of these artifact measures have been described above.

In step 1120, coding parameters or the transform coefficients, e.g., quantized DCT coefficients, are obtained from the encoded bitstream. When the encoded bit stream is available, these encoding parameters and the quantized DCT coefficients themselves can also be used as features for the NRQ calculation. In other words, the coding parameters and the transform coefficients are beneficial in assisting the present no-reference quality (NRQ) measuring prediction.

To illustrate, adjacent quantized DC coefficients together with the quantization level can help to distinguish real blocking artifacts from image features that looks like blocking artifacts. For example, if the quantization scale is particularly high, then the present invention may determine that any perceived artifacts are in deed artifacts. Alternatively, if the quantization scale is relatively low, then the present invention may determine that any perceived artifacts are simply actual features of the original image sequence and that the quality of the image sequence is actually acceptable.

Additionally, quantized AC coefficients can help to distinguish real ringing artifact from texture. Similarly, if the quantization scale is particularly high, then the present invention may determine that any perceived artifacts are in deed artifacts. Alternatively, if the quantization scale is relatively low, then the present invention may determine that any perceived artifacts are simply actual features of the original image sequence and that the quality of the image sequence is actually acceptable.

Alternatively, even if the bit stream is not available, the encoding parameters and the quantized DCT coefficients can still be estimated. For example, the bit rate can be estimated either through computing the conditional entropy of the image sequence or coding the decoded sequence again at a very high bit rate. Similarly, the quantization tables can be estimated through the histogram of quantized DCT coefficients of the sequence re-compressed using MPEG.

In step 1130, method 1100 generates a prediction. To illustrates, after obtaining the measures of ringing, quantization, resolution and sharpness artifacts, the no-reference quality (NRQ) measure of an entire sequence is formulated as a function of these artifact measures. For example, it can be a linear combination of the first order, and cross terms of the four measures and a constant term. Let R, V, E and S be the values of the average ringing artifact measure, the average quantization artifact measure, the average perceived resolution artifact measure and the average sharpness artifact measure over the entire sequence. Then, the NRQ can be expressed as:

RFQ=a₁R+a₂V+a₃E+a₄S+a₅RV+a₆RE+a₇RS+a₈VE+a₉VS+a₁₀ES+a₁₁ Equ. (13)

where aᵢ, i=1, 2, . . . 11 are calculated from training images using minimal mean squared error estimate.

As an example, when the bit-rate B of the compressed sequence is available, the NRQ can also be computed as:

$$\begin{matrix}RFQ = {a}_{1} R + {a}_{2} V + {a}_{3} E + {a}_{4} S + {a}_{5} B + \\ {a}_{6} RV + {a}_{7} RE + {a}_{8} RS + {a}_{9} RB + \\ {a}_{10} VE + {a}_{11} VS + {a}_{12} VB + \\ {a}_{13} ES + {a}_{14} EB + {a}_{15}\end{matrix} \qquad Equ . ( 14 )$$

where aᵢ, i=1, 2, . . . 15 are the weights also calculated from training images using minimal mean squared error estimate.

It should be noted that the present invention can be generalized to implement a method of partitioning an image sequence into spatio-temporal regions with different properties, and measuring NRQ for different regions using different no-reference measured according to the property of that region. For example, partition image sequence into:

spatio-temporal uniform regions, e.g. blocking, banding measures can be computed;

spatio-temporal texture regions, e.g. temporal flicking measures can be computed;

fast-moving temporal regions, e.g. motion discontinuity measure can be computed;

static high spatial contract regions, such as static edges, e.g. ringing measure moving but trackable high spatial contract regions, move edges with predictable behavior, e.g. ringing/flicking measure moving and un-trackable high spatial contract regions, e.g. consistent motion behavior.

Alternatively, the present invention can be adapted for implementing a method of estimating virtual reference video sequences from the processed video sequence and then using the virtual reference as true reference to compute the NRQ of the processed video as if the reference is available. In other words, various image processing steps can be used to improve the quality of an image sequence. Once such processing is accomplished, it is now possible to use the newly processed image sequence as a virtual “reference” image sequence.

For example, the following virtual reference video generation algorithms can be employed:

De-noising algorithms, such as de-ringing, de-blocking, de-blurring can be used to generate a virtual reference.

Learning based virtual reference generation. Learning linear/non-linear mapping functions from a set of original videos and their corresponding processed video sequences. One of the non-linear functions can be the artificial neural networks.

After a virtual reference is computed, a video quality metrics, such as the Sarnoff JNDmetrix can be used to compute the video quality by comparing the virtual reference and the processed video sequences.

It should be noted that the present invention describes the use of thresholds in various methods. These thresholds can be selected to meet a particular implementation requirement. Additionally, these thresholds can be deduced during training, where a human evaluator can evaluate the results and then assign quality ratings or scores. In turn, it is possible to assess these ratings and scores in a empirical process to determine the proper threshold for each of the above mentioned methods.

While the foregoing is directed to illustrative embodiments of the present invention, other and further embodiments of the invention may be devised without departing from the basic scope thereof.

1. A method for evaluating quality of a processed image, comprising the steps of:
generating at least one artifact measure; and
generating a no-reference quality measure from said at least one artifact measure, where said no-reference quality measure represents a quality measure of the processed image.

2. The method of claim 1, wherein said no-reference quality measure is generated directly from said processed image.

3. The method of claim 1, where said at least one artifact measure comprises a ringing artifact measure.

4. The method of claim 3, wherein said generating at least one ringing artifact measure comprises:
segmenting the processed image into at least one uniform region;
identifying at least one edge within the processed image; and
defining at least one region adjacent to said at least one edge.

5. The method of claim 4, wherein said at least one ringing artifact measure is generated in accordance with:
$${R}_{i , j} = \{ \begin{matrix}\frac{var ( {E}_{i , j} )}{var ( {U}_{i} )} , & ∃ i , j ∋ x ε {E}_{i , j} ⋀ \vert {E}_{i , j} \vert > M \\ 0 , & otherwise\end{matrix}$$
where R_{i,j} denotes said ringing artifact measure, var(E_{i,j}) denotes variance of E_{i,j}, var(Uᵢ) denotes variance of a uniform region uᵢ, E_{i,j} denotes an j^{th} connected component of the intersection of a region adjacent to said at least one edge e and Uᵢ, and M is a threshold.

6. The method of claim 4, wherein said at least one region adjacent to said at least one edge is defined in accordance with a coding block size.

7. The method of claim 1, where said at least one artifact measure comprises a quantization artifact measure.

8. The method of claim 7, wherein said generating at least one quantization artifact measure comprises:
computing at least one horizontal contrast at each pixel location;
computing at least one vertical contrast at each pixel location;
filtering at least one of said horizontal contrast and vertical contrast; and
summing said filtered horizontal contrast and vertical contrast over a sliding window.

9. The method of claim 8, wherein said at least one quantization artifact measure is generated in accordance with:
V_{i,j}=max(|S_{i,j}^{h}+S_{i,j}^{v}|,|S_{i,j}^{h}−S_{i-7,j}^{v}|,|S_{i,j-7}^{h}+S_{i,j}^{v}|,|S_{i,j-7}^{h}+S_{i-7,j}^{v}|)
where V_{i,j} denotes a quantization artifact measure, S_{i,j}^{h} denotes a sum of horizontal contrasts over a window and S_{i,j}^{v} denotes a sum of vertical contrasts over a window.

10. The method of claim 1, where said at least one artifact measure comprises a resolution artifact measure.

11. The method of claim 10, wherein said generating at least one resolution artifact measure comprises:
applying a fast fourier transform to the processed image; and
computing an average of amplitudes of all directions at a frequency.

12. The method of claim 1, where said at least one artifact measure comprises a sharpness artifact measure.

13. The method of claim 12, wherein said generating at least one sharpness artifact measure comprises:
detecting at least one edge in the processed image; and
computing an edge strength for each of said detected edge.

14. The method of claim, further comprising:
obtaining at least one coding parameter from the compressed image sequence, wherein said no-reference quality measure is generated from said at least one artifact measure and said at least one coding parameter.

15. The method of claim 14, wherein said at least one coding parameter comprises a target bit rate, a quantization factor, or a quantization table.

16. The method of claim 1, further comprising:
generating a map of said processed image in accordance with said at least one artifact measure.

17. The method of claim 1, wherein said at least one artifact measure is generated in accordance with spatio-temporal regions with different properties.

18. The method of claim 1, further comprising:
generating a virtual reference image directly from said processed image.

19. An apparatus for evaluating quality of a processed image, comprising the steps of:
means for generating at least one artifact measure; and
means for generating a no-reference quality measure from said at least one artifact measure, where said no-reference quality measure represents a quality measure of the processed image.

20. A computer-readable medium having stored thereon a plurality of instructions, the plurality of instructions including instructions which, when executed by a processor, cause the processor to perform the steps comprising of:
generating at least one artifact measure; and
generating a no-reference quality measure from said at least one artifact measure, where said no-reference quality measure represents a quality measure of the processed image.
